(19) United States
(12) Patent Application Publication
(10) Pub. No.: US 2026/0333186 A1
(43) Pub. Date: Oct. 22, 2026

(54) FAST INDIRECT PATH ESTABLISHMENT FOR SIDELINK USER EQUIPMENT TO NETWORK RELAY

(71) Applicant: Nokia Technologies Oy, Espoo (FI)

(72) Inventors: Ling YU, Espoo (FI); Vinh VAN PHAN, Oulu (FI); Faranaz SABOURI-SICHANI, Aalborg (DK); Xiang XU, Beijing (CN); Berthold PANZNER, Munich (DE); Stepan KUCERA, Munich (DE); Ravi Prasad R K, Bangalore (IN); György Tamás WOLFNER, Budapest (HU)

(21) Appl. No.: 19/119,534

(22) PCT Filed: Oct. 14, 2022
(86) PCT No.: PCT/CN2022/125422

§ 371 Date: Apr. 9, 2025

(51) Int. Cl. H04W 40/22; H04W 76/14; H04W 88/04

(52) U.S. Cl. CPC H04W 40/22; H04W 76/14; H04W 88/04

(57) ABSTRACT

Systems, methods, apparatuses, and computer program products for setting up an indirect path as an additional path in cases where a relay user equipment may be in idle or inactive state, such as radio resource control idle/inactive are provided. For example, a method can include receiving, from a network element, a configuration of a relay user equipment container related to an addition to, or modification of, an indirect path between the apparatus and the network element. The method can also include indicating the relay user equipment container to a relay user equipment.

### FIELD

Some example embodiments may generally relate to communications including mobile or wireless telecommunication systems, such as Long Term Evolution (LTE) or fifth generation (5G) radio access technology or new radio (NR) access technology, or other communications systems including subsequent generations of the same or similar standards. For example, certain example embodiments may generally relate to setting up an indirect path as an additional path in cases where a relay user equipment may be in idle or inactive state, such as radio resource control idle/inactive state.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. From release 18 (Rel-18) onward, 5G is referred to as 5G advanced. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IOT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 6G is currently under development and may replace 5G and 5G advanced.

### SUMMARY

An embodiment may be directed to an apparatus. The apparatus may include at least one processor and at least memory storing instructions. The instructions, when executed by the at least one processor, may cause the apparatus at least to perform receiving, from a network element, a configuration of a relay user equipment container related to an addition to, or modification of, an indirect path between the apparatus and the network element. The instructions, when executed by the at least one processor, may also cause the apparatus at least to perform indicating the relay user equipment container to a relay user equipment.

An embodiment may be directed to an apparatus. The apparatus may include at least one processor and at least memory storing instructions. The instructions, when executed by the at least one processor, may cause the apparatus at least to perform receiving a relay user equipment container from a remote user equipment. The instructions, when executed by the at least one processor, may also cause the apparatus at least to perform connecting to a network element based on the relay user equipment container to provide an indirect path for the remote user equipment.

An embodiment may be directed to an apparatus. The apparatus may include at least one processor and at least memory storing instructions. The instructions, when executed by the at least one processor, may cause the apparatus at least to perform configuring a remote user equipment with a relay user equipment container related to an addition to, or modification of, an indirect path between the remote user equipment and the apparatus. The instructions, when executed by the at least one processor, may also cause the apparatus at least to perform receiving confirmation of delivery of the relay user equipment container to a relay user equipment.

An embodiment may be directed to a method. The method can include receiving, at a user equipment from a network element, a configuration of a relay user equipment container related to an addition to, or modification of, an indirect path between the user equipment and the network element. The method can also include indicating the relay user equipment container to a relay user equipment.

An embodiment may be directed to a method. The method can include receiving, at a user equipment, a relay user equipment container from a remote user equipment. The method may also include connecting to a network element based on the relay user equipment container to provide an indirect path for the remote user equipment.

An embodiment may be directed to a method. The method can include configuring a remote user equipment with a relay user equipment container related to an addition to, or modification of, an indirect path between the remote user equipment and a network element. The method may also include receiving confirmation of delivery of the relay user equipment container to a relay user equipment.

An embodiment can be directed to an apparatus. The apparatus can include means for receiving, from a network element, a configuration of a relay user equipment container related to an addition to, or modification of, an indirect path between the apparatus and the network element. The apparatus can also include means for indicating the relay user equipment container to a relay user equipment.

An embodiment can be directed to an apparatus. The apparatus can include means for receiving a relay user equipment container from a remote user equipment. The apparatus can also include means for connecting to a network element based on the relay user equipment container to provide an indirect path for the remote user equipment.

An embodiment can be directed to an apparatus. The apparatus can include means for configuring a remote user equipment with a relay user equipment container related to an addition to, or modification of, an indirect path between the remote user equipment and the apparatus. The apparatus can also include means for receiving confirmation of delivery of the relay user equipment container to a relay user equipment.

### BRIEF DESCRIPTION OF THE DRAWINGS

For proper understanding of example embodiments, reference should be made to the accompanying drawings, wherein:

FIG. 1 illustrates targeted multi-path for a remote user equipment;

FIG. 2 illustrates a signaling flow of a method according to certain embodiments;

FIG. 3 illustrates a radio resource control setup message; and

FIG. 4 illustrates an example block diagram of a system, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing setting up an indirect path as an additional path in cases where a relay user equipment may be in idle or inactive state, such as radio resource control idle/inactive, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain embodiments relate to support of multi-path (MP) for user equipment (UE) in which one path is using new radio (NR) sidelink (SL) based layer two (L2) UE-to-Network (U2N) relay, also referred to as an indirect path, and the other path is using direct Uu access, also referred to as a direct path. It is possible that multi-path with U2N relay or UE aggregation may improve the throughput and reliability or robustness of a communication, for example, for UEs at the edge of a cell, and UEs with limited uplink (UL) transmission power. In wireless communications, there is also a usage of the term, multipath, to refer to a condition where a signal propagates along a direct path from a transmitter to a receiver and along a second path due to, for example, reflection. MP for UE may refer instead to an intentionally created situation in which there are different signals providing a communication link(s) to a user equipment through different transmission paths. The present discussion focuses on MP for UE rather than on signal reflection and related signal interference/fading issues.

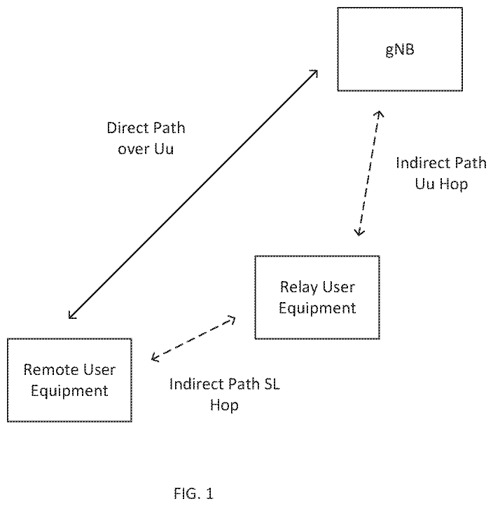

FIG. 1 illustrates targeted multi-path for a remote user equipment. If the same mechanism of network (NW) controlled SL U2N relay indirect path switching is used, the MP management may be under the control of NW, such as the next generation Node (gNB), for managing the MP, especially for L2 based U2N relay in indirect path. MP management can include decision on setup of MP, selection of relay UE for indirect path, configuration of indirect path, or the like.

Certain embodiments relate to the scenario as illustrated in FIG. 1, where the UE has already established at least the direct path with the serving gNB. The gNB can determine in addition to the established direct path to add a new or modify an existing indirect path, the dotted path in FIG. 1, via a selected relay UE, where the relay UE can be in RRC idle or inactive state before the indirect path via the relay UE for the remote UE is established.

The gNB may identify that the direct path cannot meet the throughput or reliability requirements of the remote UE's service traffic, for example based on the gNB's own measurement and/or measurement reports from the remote UE. Thus, the serving gNB of the remote UE may determine to add or modify the indirect path via the selected relay UE. It may be beneficial to set up the indirect path as soon as possible in order to maintain good quality of service (QOS) for the remote UE's service.

Following one mechanism of indirect path switching via the relay UE in RRC idle/inactive state, upon the serving gNB configuring the remote UE for indirect path switching, the relay UE in RRC idle/inactive state may be triggered by the remote UE over sidelink (SL) or PC5 to set up the relay UE's own RRC connection with the serving gNB. Only after the relay UE enters RRC connected state, the remote UE's indirect path can be set up, using this example mechanism. The total RRC connection establishment procedure latency may be between 70-80 ms for the direct connection establishment between UE and the serving gNB and 50 ms with latency improvement features described in third generation partnership project (3GPP) technical specification (TS) 36.912.

Thus, indirect path establishment in MP scenario may be delayed at least for tens of milliseconds if a relay UE is in RRC idle/inactive state. This may not be acceptable when a remote UE's service has a guaranteed bit rate or an expectation of high reliability and low latency.

Certain embodiments provide a way to set up the indirect path as the second path in a fast and efficient way when the indirect path is configured via the relay UE in RRC idle/inactive state.

Thus, certain embodiments can utilize the existing direct path between the remote UE and the serving gNB to facilitate a fast and efficient RRC connection establishment for the relay UE(s) in RRC idle/inactive state when the indirect path is added or modified utilizing a new relay UE.

The remote UE can be configured by a network element, such as a gNB or any other access node. Specifically, the remote UE can be configured with the relay UE RRC connection configuration container, which can be referred to as a relay UE container. The relay UE container can provide the RRC reconfiguration parameters related to addition or modification of the indirect path.

The relay UE container may include configuration for the relay UE as would otherwise be included in an RRCSetup message such as, but not limited to, Uu signaling radio bearer 1 (SRB1) configuration, PC5 configuration of SRB1 message, and optional cell radio network temporary identifier (C-RNTI). The PC5 configuration can include sidelink relay adaptation protocol (SRAP), radio link control (RLC)-channel, medium access control (MAC) and physical layer (PHY) configuration.

The relay UE container may also include uplink (UL) synchronization related configuration. For example, the configuration may include a dedicated RACH preamble for the relay UE to gain quick UL synchronization with a serving gNB via contention free RACH procedure. In addition, or as an alternative, the relay UE container can include timing-advance (TA) information for RACH-less access, which may be determined by the serving gNB based on TA info of the remote UE and a measurement report from the remote UE over PC5 between the remote UE and the relay UE. The relay UE container may also include much more information such as Uu SRB1 configuration, PC5 configuration (for example, SRAP, RLC-channel, MAC and PHY configuration) of SRB1 message, and optional C-RNTI. Other information may likewise be included in the relay UE container.

Upon receiving the MP addition/modification configuration with the relay UE container, the remote UE can establish PC5 connection with the relay UE and can indicate the relay UE container to the relay UE. Upon receiving the relay UE container, the relay UE may omit at least some procedures of the regular RRC connection establishment procedure. The following are some examples, but other procedures of the regular RRC connection establishment procedure may also be considered and optionally omitted.

If the relay UE container from the serving gNB includes valid TA information or the remote UE indicates valid TA information to the relay UE, the relay UE may use the indicated TA for communication with the gNB over Uu and start monitoring PDCCH over Uu to send a confirmation message to the gNB to complete RRC connection establishment procedure of the relay UE right away.

If the relay UE container from the serving gNB indicates the RACH preamble, the relay UE may initiate RACH procedure using the RACH preamble and can send the confirmation message, instead of an RRCSetupRequest, in msg3 of the RACH procedure to complete RRC connection establishment procedure of the relay UE.

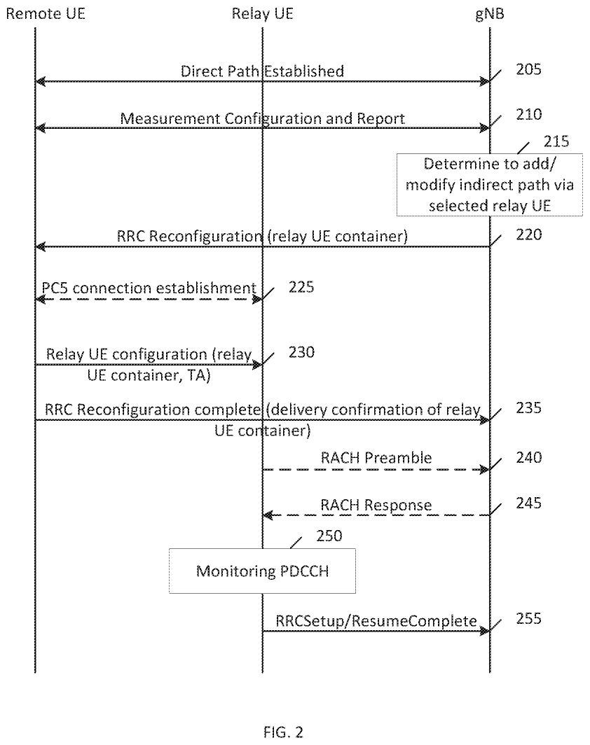

Additionally, the remote UE can respond to the serving gNB using a RRC reconfiguration complete message. The message can indicate the delivery of the relay UE container to the relay UE. The indication of the delivery of the relay UE container may be particularly useful for the RACH-less option described above. The indication can be used by the serving gNB to start scheduling the relay UE for the confirmation message transmission in UL FIG. 2 illustrates a signaling flow of a method according to certain embodiments. FIG. 2 illustrates an implementation example for fast and efficient indirect path establishment for multipath.

The remote UE may have at least a direct path established with the serving gNB at procedure 205. In procedure 210, the gNB can configure the remote UE with a measurement configuration, which may include the measurement on relay UEs over a PC5 interface. According to the measurement configuration, in procedure 210 the remote UE may report Uu and PC5 measurement results, in which the PC5 measurement results may include the discovered candidate relay UEs' ID, serving cell ID, the PC5 measurement quantity results, remote UE's location information if available, and the like.

Based on the measurement report from the remote UE, the serving gNB at 215 may make a decision to add or modify an indirect path via a selected relay UE for the remote UE. Adding the indirect path for the remote UE may be applied if the remote UE has only the direct path established with the serving gNB. Modifying the indirect path for the remote UE may be applied if the remote UE has both direct path and indirect path established with the serving gNB and the serving gNB decides to modify the indirect path with a relay reselection from the current, or source, relay UE to the newly selected, or target, relay UE. While it is possible to modify the characteristics of an indirect path with an existing relay UE without changing to a new relay UE, in such a case the existing relay UE may already be connected to the serving gNB, and accordingly techniques to accelerate connection establishment may be unnecessary. If, however, such accelerated connection establishment is desired, the same techniques as described herein may be applied.

According to the relay UEs' ID reported by the remote UE, the serving gNB may identify that the (re)selected relay UE is not in RRC connected state and therefore that the relay UE needs to set up the relay UE's own RRC connection with the serving gNB before the indirect path can be established.

To facilitate the fast and efficient indirect path setup for the remote UE, the serving gNB may decide to include the relay UE's RRC connection configuration in a relay UE container inside the RRC reconfiguration message to be sent, in procedure 220, to the remote UE to configure the remote UE to add or modify the indirect path via the (re)selected relay UE and provide the relay UE container to the relay UE over PC5 interface.

In procedure 225, the remote UE may establish a PC5 connection to the selected relay UE, if not already connected. Then, in procedure 230, the UE may transmit the configuration received in the container to the relay UE.

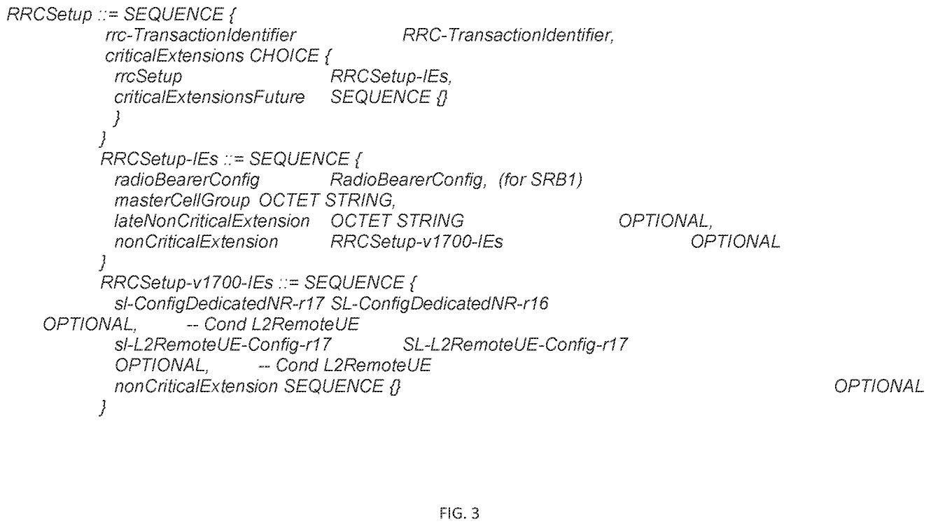

FIG. 3 illustrates a radio resource control setup message. The configuration information in the relay UE container provided in procedure 220 of FIG. 2 may include some, many, or all of the configuration parameters in the RRCSetup message as shown in FIG. 3, as well as other configuration parameters.

In addition to the configuration parameters, such as those associated with an RRCSetup message, the relay UE container may also include the configuration parameters for UL synchronization for the relay UE. In one option, the RACH configuration parameters, such as a dedicated RACH preamble, can be provided. The RACH configuration parameters can be used by the relay UE to initiate the RACH procedure for obtaining timing advance (TA) information from the gNB. For example, the relay can send a RACH preamble at 240 and receive a RACH response at 245.

As another option, the TA information may be provided by the gNB in a relay container and the TA may be used by the relay UE for the relay UE's UL transmission to the serving gNB. In this option, the gNB may provide the TA information based on the remote UE's TA in the direct path and/or location information of the relay UE and remote UE if such information is available.

As yet another option, the serving gNB may not provide either RACH preamble or TA, but may indicate to the remote UE to provide the remote UE's TA information to the relay UE.

Depending on whether RACH configuration is provided in the relay UE container or not, C-RNTI for the relay UE may or may not be provided in the relay UE container. For example, if RACH configuration is provided, the relay UE can get a temporary C-RNTI allocated in RACH response message and the temporary C-RNTI can be promoted as normal C-RNTI if RACH procedure is successful. In this case, C-RNTI does not need to be included in the relay UE's container. However, if TA is configured in the relay UE container from the gNB or the gNB indicates/requests the remote UE to provide TA to the relay UE, the C-RNTI of the relay UE may be included in the relay UE container.

As one implementation option, the relay UE container may be provided by the serving gNB without indicating the (re-)selected target relay UE. In this case, the remote UE may select the relay UE for indirect path. The relay UE container received from the serving gNB can be indicated to the selected relay UE by the remote UE as discussed below.

In addition to the relay UE container, the allocated PC5 resources, such as an SL configured grant, may be also provided by the gNB to the remote UE in the RRC Reconfiguration message. Such indication of the allocated PC5 resources may facilitate the remote UE to transmit the remote UE's SL control signaling and data faster and more reliably over PC5 interface to the relay UE, without the need for resource sensing and selection.

The configuration of SRB1 for Uu and PC5 in RRCSetup message may not take into account the UE capability, because the UE capability may not be available in the serving gNB when RRCSetup message is transmitted. In addition, the RRCSetup message may not be encrypted, as the security mode may not have been activated when the message is transmitted from the gNB to the remote UE. Therefore, there may be no UE capability mismatch issue or security issue to deliver the RRC connection configuration parameters to the relay UE via the remote UE.

When the remote UE receives the RRC Reconfiguration message for the indirect path addition or modification, the remote UE may need to establish the PC5 connection with the target relay UE indicated for the indirect path if the PC5 connection has not been set up with the relay UE before. Then the remote UE may forward the relay UE container to the relay UE over the PC5 connection.

In one option, the relay UE container may be forwarded to the relay UE in a PC5 connection establishment procedure. For example, the container may be integrated into the SL RRC reconfiguration message. In another option, a new SL RRC message may be introduced to forward the relay UE container to the relay UE.

The remote UE may determine the delivery of the relay UE container to the relay UE either based on hybrid automatic repeat request (HARQ) acknowledgment (ACK) feedback from PHY/MAC layer if HARQ feedback is enabled for delivering the relay UE container over PC5. Alternatively, the remote UE may determine the delivery of the relay UE container to the relay UE based on SL RRC procedures. For example, the RRC confirmation message, which may be SL RRC reconfiguration complete, can be used as the delivery confirmation from the relay UE.

In procedure 235, upon determining the delivery of the relay UE container to the relay UE, the remote UE can respond to the serving gNB with an RRC reconfiguration complete message, in which the indication of the delivery of the relay UE container to the relay UE is indicated. Based on this indication, the serving gNB can be aware of the relay UE's reception of the RRC connection configuration and therefore prepare for the following actions.

In a case where a RACH configuration is included in the relay UE container, the gNB can detect the dedicated RACH preamble when provided at 240 and then schedule UL resources to the relay UE for RACH msg3 transmission to allow the relay UE to send, in procedure 255, a confirmation message to the gNB for the RRC connection setup or resume in case the relay UE is in RRC inactive state.

In case RACH configuration is not included in the relay UE container, the gNB may schedule UL resources to the relay UE upon receiving the delivery indication from the remote UE. The UL resource can be used by the relay UE to send the confirmation message to the gNB for the RRC connection setup/resume.

Correspondingly, the relay UE, upon receiving the relay UE container forwarded from the remote UE, may either initiate RACH procedure if RACH configuration provided in the container or, in procedure 250, monitor the PDCCH using the C-RNTI included in the container for UL resource allocation to send the confirmation message for RRC connection setup/resume. The confirmation message may be either a new RRC message or a reused RRC setup complete or RRC resume complete message.

Upon receiving the candidate relay UE report from the remote UE, the serving gNB, based on the relay UE's ID, may only identify that the relay UE is not in RRC connected state, but may not be able to differentiate as to whether the relay UE is in RRC idle state or RRC inactive state. Thus, the relay UE container may only include the configuration parameters similar to those in an RRCSetup message. Providing additional configuration, such as data radio bearer (DRB) configurations as in an RRCResume message, may not be possible. However, the relay UE may, based on the relay UE's RRC state, provide different information in the confirmation message. For instance, different UE ID, such as fifth generation temporary mobile subscriber identity (5G-TMSI) or inactive radio network temporary identifier (I-RNTI) may be provided in the confirmation message for the relay UE in RRC idle or RRC inactive state respectively.

The implementation example of FIG. 2 is described for a scenario in which the direct and indirect paths are connected to the same serving gNB. The same mechanism can also be applied for a scenario in which the direct path and indirect path are connected to different gNBs. In such a case, the gNB that the indirect path is connected to can provide the relay UE container via inter-gNB interface, such as Xn interface or N2 interface, to the gNB to which the direct path is connected.

Certain embodiments are described in a multipath scenario where a UE has at least a direct path to a gNB with or without a second indirect path, and it is decided by gNB to add a second indirect path, or to modify the second indirect path if the second indirect path exists, via a (re)selected Relay UE while the direct path is maintained. The approach for fast setup of indirect path can also be applicable in a single path scenario where a path switch from direct to indirect is triggered, such that the remote UE receives the configuration or TA via the remote UE's current path and transmits to the target relay UE for fast path switch. Likewise, certain embodiments may also be applicable to add a third path, where a direct path and an indirect path already exist and are to be maintained.

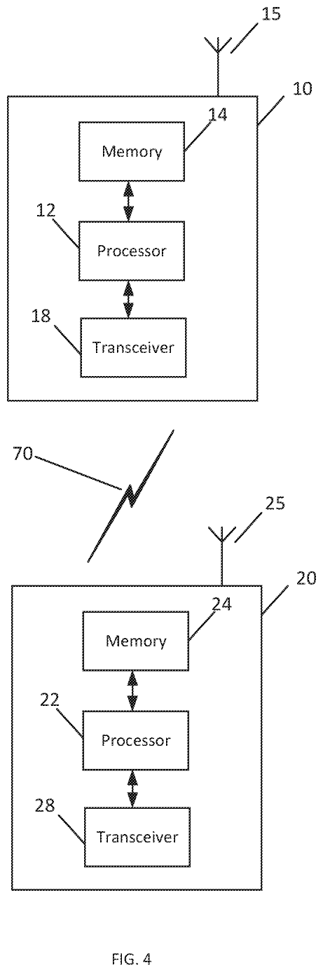

FIG. 4 illustrates an example of a system that includes an apparatus 10, according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may include an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a mid-haul interface, referred to as an F1 interface, and the DU(s) may have one or more radio unit (RU) connected with the DU(s) over a front-haul interface. The DU may be a logical node that includes a subset of the gNB functions, depending on the functional split option. It should be noted that one of ordinary skill in the art would understand that apparatus 10 may include components or features not shown in FIG. 4.

As illustrated in the example of FIG. 4, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 4, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to setting up or modifying an indirect path as an additional path in cases where a relay user equipment may be in idle or inactive state, such as radio resource control idle/inactive.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be include any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-3, or any other method described herein. In some embodiments, as discussed herein, apparatus 10 may be configured to perform a procedure relating to providing setting up an indirect path as an additional path in cases where a relay user equipment may be in idle or inactive state, such as radio resource control idle/inactive, for example.

FIG. 4 further illustrates an example of an apparatus 20, according to an embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IOT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IOT, Bluetooth, NFC, MulteFire, and/or any other radio access technologies. It should be noted that one of ordinary skill in the art would understand that apparatus 20 may include components or features not shown in FIG. 4.

As illustrated in the example of FIG. 4, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 4, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can include any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IOT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDM symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IOT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-3, or any other method described herein. For example, in an embodiment, apparatus 20 may be controlled to perform a process relating to providing setting up or modifying an indirect path as an additional path in cases where a relay user equipment may be in idle or inactive state, such as radio resource control idle/inactive, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may provide various benefits and/or advantages. For example, certain embodiments may provide a way to provide a greatly accelerated connection setup or modification even when a relay UE is in RRC idle or RRC inactive. Certain embodiments may benefit the creation or modification of an indirect path in a multipath scenario.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium. The term “non-transitory” as used herein, is a limitation of the medium itself (i.e. tangible, not a signal) as opposed to a limitation on data storage persistency (e.g. RAM vs. ROM).

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

ACK positive Acknowledgement
C-RNTI Cell-Radio Network Temporary Identifier
gNB gNodeB
HARQ Hybrid Automatic Repeat Request
I-RNTI Inactive-Radio Network Temporary Identifier
MP Multi-Path
PC5 a reference point where the UE directly communicates
with another UE over a direct channel
PDCCH Physical Downlink Control Channel
RACH Random Access Channel
RRC Radio Resource Control
SL SideLink
TA Timing Advance
TMSI Temporary Mobile Subscriber Identity
U2N UE to Network
U2U UE to UE
UE User Equipment
UL Uplink

(1-53) canceled

54. An apparatus, comprising:
at least one processor; and
at least one memory storing instructions that, when executed by the at least one processor, cause the apparatus at least to perform
receiving, from a network element, a configuration of a relay user equipment container related to an addition to, or modification of, an indirect path between the apparatus and the network element; and
indicating the relay user equipment container to a relay user equipment.

55. The apparatus of claim 54, wherein the instructions, when executed by the at least one processor, further cause the apparatus to perform
sending, to the network element, confirmation of delivery of the relay user equipment container to the relay user equipment.

56. The apparatus of claim 55, wherein the confirmation of delivery is sent using a radio resource control configuration complete message.

57. The apparatus of claim 54, wherein the indicating comprises a sidelink signaling on a connection from the apparatus to the relay user equipment.

58. The apparatus of claim 54, wherein the instructions, when executed by the at least one processor, further cause the apparatus to perform
providing timing advance information, associated with the apparatus to communicate with the network element, to the relay user equipment, responsive to an instruction from the network element.

59. The apparatus of claim 54, wherein the instructions, when executed by the at least one processor, further cause the apparatus to perform
providing timing advance information together with the relay user equipment container.

60. The apparatus of claim 54, wherein the instructions, when executed by the at least one processor, further cause the apparatus to perform
based on the relay user equipment being unidentified in the configuration, selecting the relay network by the apparatus.

61. An apparatus, comprising:
at least one processor; and
at least one memory storing instructions that, when executed by the at least one processor, cause the apparatus at least to perform
receiving a relay user equipment container from a remote user equipment; and
connecting to a network element based on the relay user equipment container to provide an indirect path for the remote user equipment.

62. The apparatus of claim 61, wherein the connecting comprises using a dedicated random access channel access preamble from the relay user equipment container.

63. The apparatus of claim 61, wherein the connecting comprises sending a random access channel preamble to the network element based on the relay user equipment container and receiving a random access channel response from the network element.

64. The apparatus of claim 61, wherein the connecting comprises using timing advance information from the relay user equipment container.

65. The apparatus of claim 64, wherein the instructions, when executed by the at least one processor, further cause the apparatus to perform
monitoring a downlink control channel using at least one of the timing advance information or a cell radio network temporary identifier from the relay user equipment container.

66. A method, comprising:
receiving, at a user equipment from a network element, a configuration of a relay user equipment container related to an addition to, or modification of, an indirect path between the user equipment and the network element; and
indicating the relay user equipment container to a relay user equipment.

67. The method of claim 66, further comprising:
sending, to the network element, confirmation of delivery of the relay user equipment container to the relay user equipment.

68. The method of claim 67, wherein the confirmation of delivery is sent using a radio resource control configuration complete message.

69. The method of claim 66, wherein the indicating comprises a sidelink signaling on a connection from the user equipment to the relay user equipment.

70. The method of claim 66, further comprising:
providing timing advance information, associated with the user equipment to communicate with the network element, to the relay user equipment, responsive to an instruction from the network element.

71. The method of claim 66, further comprising:
providing timing advance information together with the relay user equipment container.

72. The method of claim 66, further comprising:
based on the relay user equipment being unidentified in the configuration, selecting the relay network by the user equipment.
